(19) United States
(12) Patent Application Publication
(10) Pub. No.: US 2017/0193784 A1
(43) Pub. Date: Jul. 6, 2017

(54) Dual Code Authentication Device

(71) Applicant: Maier E. Fried, Monsey, NY (US)

(72) Inventor: Maier E. Fried, Monsey, NY (US)

(21) Appl. No.: 14/986,062

(22) Filed: Dec. 31, 2015

(51) Int. Cl. G08B 15/00; G08B 13/22; G07C 9/00; G06Q 20/10

(52) U.S. Cl. CPC G08B 15/001; G06Q 20/1085; G08B 13/22; G07C 9/00817; G07C 2009/00833

(57) ABSTRACT

A dual code authentication device has a primary code which accesses a system, such as a banking system, in a conventional manner. The device further has an emergency code which accesses the system and triggers transmission of an alert such that a user may alert authorities the system is being accessed under duress while still appearing to cooperate with a potential thief. The device includes a system which is accessible upon entry of a primary code into an input. The system is also accessible upon entry of an emergency code into the input. A transmitter coupled to the input transmits an alert upon entry of the emergency code into the input wherein entry of the emergency code alerts authorities that accessing the system is being made under duress.

### BACKGROUND OF THE DISCLOSURE

Field of the Disclosure

The disclosure relates to authentication devices and more particularly pertains to a new authentication device having a primary code which conventionally accesses a system and an emergency code which accesses the system and triggers transmission of a silent alert such that a user may surreptitiously alert authorities of a threat while still appearing to cooperate with a potential thief.

### SUMMARY OF THE DISCLOSURE

An embodiment of the disclosure meets the needs presented above by generally comprising a system which is accessible upon entry of a primary code into an input. The system is also accessible upon entry of an emergency code into the input. A transmitter coupled to the input transmits an alert upon entry of the emergency code into the input wherein entry of the emergency code alerts authorities that accessing the system is being made under duress.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a schematic view of a dual code authentication device according to an embodiment of the disclosure.

### DESCRIPTION OF THE PREFERRED EMBODIMENT

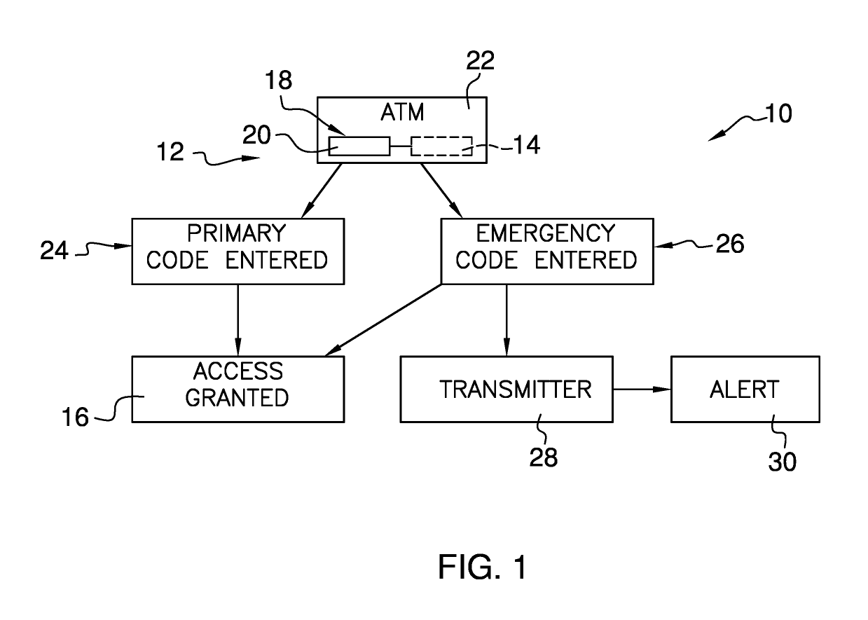

With reference now to the drawings, and in particular to FIG. 1 thereof, a new authentication device embodying the principles and concepts of an embodiment of the disclosure and generally designated by the reference numeral 10 will be described.

As best illustrated in FIG. 1, the dual code authentication device 10 generally comprises a system 12 requiring authentication of identity to provide access to the system 12. For purposes of this disclosure, authentication of identity includes the use of a personal identification code, password, or the like, which is commonly known as a way of identifying authorized users as opposed to technically confirming actual identity of the particular user. The system 12 comprises a banking program 14 accessing a bank account 16. Further, the system 12 may be interpreted as being a physical obstruction or lock which is opened in a like manner using identity authentication.

An input 18 is communicatively coupled to the system 12. In an embodiment, the input 18 is a keypad 20 coupled to an automated teller machine 22. The system 12 is accessed upon entry of a primary code 24 into the input 18. Unlike conventional authorization protocols, the system 12 is further accessible upon entry of an emergency code 26 into the input 18 as an alternative to the primary code 24. A transmitter 28 is coupled to the input 18. The transmitter 28 transmits an alert 30 upon entry of the emergency code 26 into the input 18. The primary code 24 is a first combination of either numbers exclusively or alphanumeric characters. The emergency code 26 is a second combination of numbers exclusively, or alphanumeric characters, different than the first combination. The primary code 24 and the emergency code 26 have an equal number of numbers or characters to inhibit recognition of entry of the emergency code 26 instead of the primary code 24. Thus, entry of the emergency code 26 can be used as an alternative to the primary code 24 to alert authorities that accessing of the system 12 is made under duress and help is needed. The alert 30 is broadcast to a remote location relative to an area surrounding the input 18 wherein the alert 30 is configured not to be noticeable by persons near the input 18. As stated above, entry of the emergency code 26 does provide access to the system 12 allowing for an otherwise normal transaction. In contrast to a fake code entry which would alert authorities without accessing the system, a transaction may take place having the appearance of a conventional transaction such that a potential perpetrator is unaware authorities have been alerted to a problem. This enhances the safety of the user during and immediately after a transaction utilizing the emergency code 26.

In use, the user enters the primary code 24 to access the system 12 when no potential threats is perceived. When threatened, or imminent danger is present, the user may enter the emergency code 26 to perform what appears to be a conventional transaction so as not to invite reprisals or endanger the user for failing to execute a transaction. Authorities are alerted upon entry of the emergency code 26 and appropriate action such as surveillance or expedited intervention may be employed. A microphone and video camera may be employed allowing video and audio to be transmitted with or as part of the alert to authorities.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A dual code identification authentication device comprising:
a system requiring authentication of identity to provide access to said system;
an input communicatively coupled to said system, said system being accessible upon entry of a primary code into said input, said system being accessible upon entry of an emergency code into said input, said input being a keypad, said primary code being a first combination of numbers, said emergency code being a second combination of numbers different than said first combination of numbers, said primary code and said emergency code having an equal number of alphanumeric characters; and
a transmitter coupled to said input, said transmitter transmitting an alert upon entry of said emergency code into said input wherein entry of said emergency code is configured for alerting authorities that accessing said system is being made under duress.

2. (canceled)

3. (canceled)

4. The device of claim 1, further comprising said alert being broadcast to a remote location relative to an area surrounding said input wherein said alert is configured not to be noticeable by persons near said input.

5. The device of claim 1, further comprising:
said input being a keypad; and
said primary code being a first combination of alphanumeric characters, said emergency code being a second combination of alphanumeric characters different than said first combination of alphanumeric characters.

6. The device of claim 1, further comprising said system comprising a banking program accessing a bank account and said input being coupled to an automated teller machine.

7. A dual code identification authentication device comprising:
a system requiring authentication of identity to provide access to said system, said system comprising a banking program accessing a bank account;
an input communicatively coupled to said system, said input being a keypad coupled to an automated teller machine, said system being accessed upon entry of a primary code into said input, said system being further being accessible upon entry of an emergency code into said input, said primary code being a first combination of alphanumeric characters, said emergency code being a second combination of alphanumeric characters different than said first combination of alphanumeric characters, said primary code and said emergency code having an equal number of alphanumeric characters; and
a transmitter coupled to said input, said transmitter transmitting an alert upon entry of said emergency code into said input wherein entry of said emergency code is configured for alerting authorities that accessing said system is being made under duress, said alert being broadcast to a remote location relative to an area surrounding said input wherein said alert is configured not to be noticeable by persons near said input.

8. A dual code identification authentication device comprising:
a system requiring authentication of identity to provide access to said system, said system comprising a banking program accessing a bank account;
an input communicatively coupled to said system, said input being a keypad coupled to an automated teller machine, said system being accessed upon entry of a primary code into said input, said system being further being accessible upon entry of an emergency code into said input, said primary code being a first combination of numbers, said emergency code being a second combination of numbers different than said first combination of numbers, said primary code and said emergency code having an equal number of numbers; and
a transmitter coupled to said input, said transmitter transmitting an alert upon entry of said emergency code into said input wherein entry of said emergency code is configured for alerting authorities that accessing said system is being made under duress, said alert being broadcast to a remote location relative to an area surrounding said input wherein said alert is configured not to be noticeable by persons near said input.

9. (canceled)
